(19) United States
(12) Patent Application Publication
(10) Pub. No.: US 2022/0383574 A1
(43) Pub. Date: Dec. 1, 2022

(54) VIRTUAL OBJECT LIP DRIVING METHOD, MODEL TRAINING METHOD, RELEVANT DEVICES AND ELECTRONIC DEVICE

(71) Applicant: Beijing Baidu Netcom Science Technology Co., Ltd., Beijing (CN)

(72) Inventors: Zhanwang ZHANG, Beijing (CN); Tianshu HU, Beijing (CN); Zhibin HONG, Beijing (CN); Zhiliang XU, Beijing (CN)

(21) Appl. No.: 17/883,037

(22) Filed: Aug. 8, 2022

(30) Foreign Application Priority Data
Oct. 28, 2021 (CN) 202111261314.3

(51) Int. Cl. G06T 13/00; G10L 15/02; G10L 15/04; G06V 10/774; G06V 40/16; G06T 7/11; G06T 5/50; G10L 15/25

(52) U.S. Cl. CPC G06T 13/00; G10L 15/02; G10L 15/04; G06V 10/774; G06V 40/171; G06T 7/11; G06T 5/50; G10L 15/25; G06T 2207/30201; G06T 2207/20221; G06T 2207/20081

(57) ABSTRACT

A virtual object lip driving method performed by an electronic device includes: obtaining a speech segment and target face image data about a virtual object; and inputting the speech segment and the target face image data into a first target model to perform a first lip driving operation, so as to obtain first lip image data about the virtual object driven by the speech segment. The first target model is trained in accordance with a first model and a second model, the first model is a lip-speech synchronization discriminative model with respect to lip image data, and the second model is a lip-speech synchronization discriminative model with respect to a lip region in the lip image data.

### CROSS-REFERENCE TO RELATED APPLICATION

This application claims priority of the Chinese patent application No. 202111261314.3 filed on Oct. 28, 2021, which is incorporated herein by reference it its entirety.

### TECHNICAL FIELD

The present disclosure relates to the field of artificial intelligence, in particular to the field of computer vision technology and deep learning technology, more particularly to a virtual object lip driving method, a model training method, relevant devices, and an electronic device.

### BACKGROUND

Along with the vigorous development of Artificial Intelligence (AI) technology and big data technology, AI technology has been widely used in our lives. As an important part of AI technology, virtual object technology is used to create an image of a virtual object through AI technology, e.g., deep learning technology, and meanwhile drive a facial expression of the virtual object to simulate a speaking action.

The driving of the facial expression is mainly used to drive a lip of the virtual object through speech, so as to achieve the synchronization between the speech and the lip. Currently, a virtual object lip driving scheme generally focuses on the lip-speech synchronization accuracy. The feature extraction is performed on a facial image of the virtual object, and lip texture and face texture corresponding to the speech are rendered so as to achieve the lip-speech synchronization.

### SUMMARY

An object of the present disclosure is to provide a virtual object lip driving method, a model training method, relevant devices and an electronic device.

In one aspect, the present disclosure provides in some embodiments a virtual object lip driving method, including: obtaining a speech segment and target face image data about a virtual object; and inputting the speech segment and the target face image data into a first target model to perform a first lip driving operation, so as to obtain first lip image data about the virtual object driven by the speech segment. The first target model is trained in accordance with a first model and a second model, the first model is a lip-speech synchronization discriminative model with respect to lip image data, and the second model is a lip-speech synchronization discriminative model with respect to a lip region in the lip image data.

In another aspect, the present disclosure provides in some embodiments a model training method, including: obtaining a first training sample set, the first training sample set including a first speech sample segment and first face image sample data about a virtual object sample; inputting the first speech sample segment and the first face image sample data into a first target model to perform a second lip driving operation, so as to obtain third lip image data about the virtual object sample driven by the first speech sample segment; performing lip-speech synchronization discrimination on the third lip image data and the first speech sample segment through a first model and a second model to obtain a first discrimination result and a second discrimination result, the first model being a lip-speech synchronization discriminative model with respect to lip image data, and the second model being a lip-speech synchronization discriminative model with respect to a lip region in the lip image data; determining a target loss value of the first target model in accordance with the first discrimination result and the second discrimination result; and updating a parameter of the first target model in accordance with the target loss value.

In yet another aspect, the present disclosure provides in some embodiments a virtual object lip driving device, including: a first obtaining module configured to obtain a speech segment and target face image data about a virtual object; and a first operation module configured to input the speech segment and the target face image data into a first target model to perform a first lip driving operation, so as to obtain first lip image data about the virtual object driven by the speech segment. The first target model is trained in accordance with a first model and a second model, the first model is a lip-speech synchronization discriminative model with respect to lip image data, and the second model is a lip-speech synchronization discriminative model with respect to a lip region in the lip image data.

In still yet another aspect, the present disclosure provides in some embodiments a model training device, including: a second obtaining module configured to obtain a first training sample set, the first training sample set including a first speech sample segment and first face image sample data about a virtual object sample; a second operation module configured to input the first speech sample segment and the first face image sample data into a first target model to perform a second lip driving operation, so as to obtain third lip image data about the virtual object sample driven by the first speech sample segment; a lip-speech synchronization discrimination module configured to perform lip-speech synchronization discrimination on the third lip image data and the first speech sample segment through a first model and a second model to obtain a first discrimination result and a second discrimination result, the first model being a lip-speech synchronization discriminative model with respect to lip image data, and the second model being a lip-speech synchronization discriminative model with respect to a lip region in the lip image data; a first determination module configured to determine a target loss value of the first target model in accordance with the first discrimination result and the second discrimination result; and a first updating module configured to update a parameter of the first target model in accordance with the target loss value.

In still yet another aspect, the present disclosure provides in some embodiments an electronic device, including at least one processor, and a memory in communication with the at least one processor. The memory is configured to store therein an instruction to be executed by the at least one processor, and the instruction is executed by the at least one processor so as to implement the above-mentioned virtual object lip driving method or the above-mentioned model training method.

In still yet another aspect, the present disclosure provides in some embodiments a non-transitory computer-readable storage medium storing therein a computer instruction. The computer instruction is executed by a computer so as to implement the above-mentioned virtual object lip driving method or the above-mentioned model training method.

In still yet another aspect, the present disclosure provides in some embodiments a computer program product including a computer program. The computer program is executed by a processor so as to implement the above-mentioned virtual object lip driving method or the above-mentioned model training method.

It should be understood that, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The following drawings are provided to facilitate the understanding of the present disclosure, but shall not be construed as limiting the present disclosure. In these drawings:

FIG. 1 is a flow chart of a virtual object lip driving method according to a first embodiment of the present disclosure;

FIG. 2 is a flow chart of a model training method according to a second embodiment of the present disclosure;

FIG. 3 is a schematic view showing a virtual object lip driving device according to a third embodiment of the present disclosure;

FIG. 4 is a schematic view showing a model training device according to a fourth embodiment of the present disclosure; and

FIG. 5 is a block diagram of an electronic device according to one embodiment of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

### First Embodiment

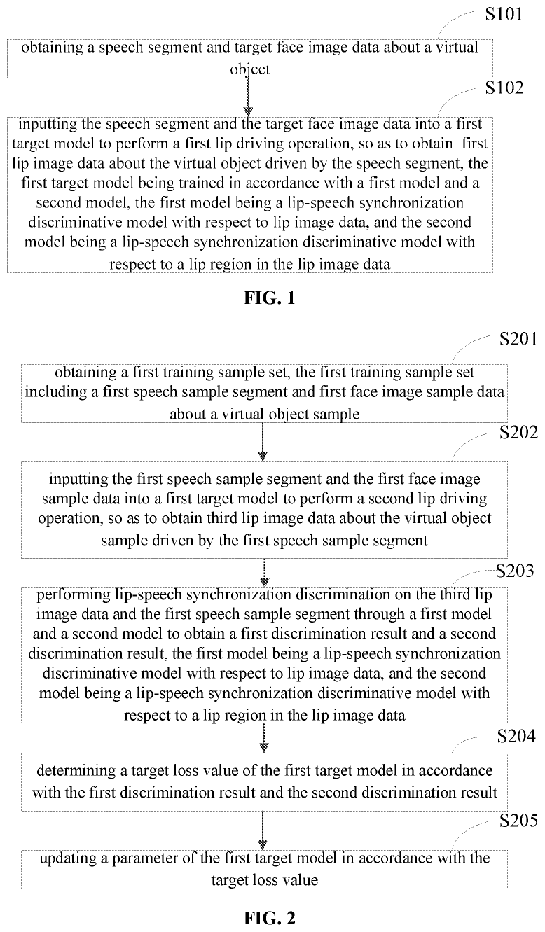

As shown in FIG. 1, the present disclosure provides in this embodiment a virtual object lip driving method, which includes the following steps.

Step S101: obtaining a speech segment and target face image data about a virtual object.

In this embodiment of the present disclosure, the virtual object lip driving method relates to the field of artificial intelligence technology, in particular to the field of computer vision technology and deep learning technology, and it is widely applied in such scenarios as face recognition. The virtual object lip driving method in the embodiments of the present disclosure is implemented by a virtual object lip driving device. The virtual object lip driving device is configured in any electronic device so as to implement the virtual object lip driving method. The electronic device is a server or a terminal, which will not be particularly defined herein.

A virtual object is a virtual human-being, a virtual animal or a virtual plant, i.e., the virtual object refers to an object having a virtual figure. The virtual human-being is a cartoon or non-cartoon human-being.

A role of the virtual object is a customer service staff, a presenter, a teacher, an idol or a tour guide, which will not be particularly defined herein. In this embodiment of the present disclosure, an object is to generate a virtual object, so as to perform a speaking operation through lip driving, thereby to enable the virtual object to realize its role and function. For example, a lip of a virtual teacher is driven so as to achieve a teaching function.

The speech segment refers to a piece of speech used to drive the lip of the virtual object, so that the lip of the virtual object is opened or closed in accordance with the speech segment, i.e., the lip of the virtual object is similar to a lip of a true person when the true person says the speech segment. In this way, a process of the virtual object's speaking is simulated through the lip driving.

The speech segment is obtained in various ways. For example, a piece of speech is recorded in real time, or a pre-stored piece of speech is obtained, or a piece of speech is received from the other electronic device, or a piece of speech is downloaded from the network.

The target face image data refers to image data including a content of a face of the virtual object. In the case that the virtual object is a virtual human-being, the target face image data is face data. The target face image data merely includes one face image, or a plurality of face images, which will not be particularly defined herein. The plurality of face images is called as a series of faces of a same virtual human-being, and poses, expressions and lips of the faces in the plurality of face images may be different.

The lip in the target face image data is entirely or partially in an open state (i.e., the virtual object is speaking), or entirely or partially in a closed state, which will not be particularly defined herein. When the lip in the target face image data is in the closed state, the target face image data is face image data where the lip is removed, i.e., the virtual object is not speaking and in a silent state.

The target face image data is presented in the form of a video or an image, which will not be particularly defined herein.

The target face image data is obtained in various ways. For example, a video is recorded or some images are taken in real time as the target face image data, or a pre-stored video or a pre-stored image is obtained as the target face image data, or a video or images is received from the other electronic device as the target face image data, or a video or image is downloaded from the network as the target face image data. The obtained video includes a face image, and the obtained image includes a face image content.

Step S102: inputting the speech segment and the target face image data into a first target model to perform a first lip driving operation, so as to obtain first lip image data about the virtual object driven by the speech segment. The first target model is trained in accordance with a first model and a second model, the first model is a lip-speech synchronization discriminative model with respect to lip image data, and the second model is a lip-speech synchronization discriminative model with respect to a lip region in the lip image data.

In this step, the first target model is a deep learning model, e.g., a Generative Adversarial Networks (GAN), and it is used to align the target face image data with the speech segment, so as to obtain the first lip image data of the virtual object driven by the speech segment.

The alignment of the target face image data with the speech segment refers to driving the lip of the virtual object to be opened or closed in accordance with the speech segment, i.e., to enable the lip of the virtual object to be similar to a lip of a true person when the true person says the speech segment, thereby to simulate a process of the virtual object's speaking through the lip driving.

The first lip image data includes a plurality of images, and it is presented in the form of a video. The video includes a series of consecutive lip images when the virtual objects says the speech segment.

The first target model is trained in accordance with the first model and the second model, and the first model and/or the second model is a part of the first target model. For example, the first target model includes a generator and a discriminator, and each of the first model and the second model is a discriminator included in the first target model. In addition, the first model and/or the second model may not be a part of the first target model, which will not be particularly defined herein.

The first model is a lip-speech synchronization discriminative model with respect to the lip image data, and it is used to determine whether the lips in a series of consecutive lip images in the lip image data synchronize with a piece of speech with respect to the lip image data and the piece of speech.

The second model is a lip-speech synchronization discriminative model with respect to the lip region in the lip image data, and it is used to determine whether the lips in a series of consecutive lip images in the image data in the lip region synchronize with a piece of speech with respect to the image data in the lip region in the lip image data and the piece of speech. The lip region of the image in the lip image data is tailored to obtain the image data in the lip region in the lip image data.

In a possible embodiment of the present disclosure, the first target model is directly trained in accordance with the first model and the second model. The first model is obtained in accordance with the target lip image sample data and the other lip image sample data, or in accordance with the target lip image sample data, and the second model is obtained in accordance with the target lip image sample data and the other lip image sample data, or in accordance with the target lip image sample data, which will not be particularly defined herein.

During the training, face image sample data is aligned with a speech sample segment through the first target model, e.g., a generator in the first target model, so as to generate the lip image data. Next, whether the generated lip image data synchronizes with the speech sample segment is determined through the first model so as to obtain a first determination result, and meanwhile whether the generated lip image data synchronizes with the speech sample segment is determined through the second model so as to obtain a second determination result. The first determination result and the second determination result are fed back to the first target model in the form of back propagation, so as to update a parameter of the first target model, thereby to enable the lip image data generated by the first target model to synchronize with the speech sample segment in a better manner.

In another possible embodiment of the present disclosure, the first target model is indirectly trained in accordance with the first model and the second model. The first target model is obtained through: training the first model in accordance with target lip image sample data to obtain a third model; training the second model in accordance with the target lip image sample data to obtain a fourth model; and training the third model and the fourth model to obtain the first target model. The target lip image sample data has a definition greater than a first predetermined threshold, and an offset angle of a face in the target lip image sample data relative to a predetermined direction is smaller than a second predetermined threshold. The predetermined direction is a direction facing an image display screen.

A process of obtaining the first target model directly through training the third model and the fourth model is similar to a process of obtaining the first target model directly through training the first model and the second model, which will not be particularly defined herein.

The first predetermined threshold may be set according to the practical need. Generally, the first predetermined threshold is set as a large value. In the case that the definition of the lip image sample data is greater than the first predetermined threshold, it means that the lip image sample data is high-definition lip image sample data, i.e., the target lip image sample data is high-definition lip image sample data.

The second predetermined threshold may also be set according to the practical need. Generally, the second predetermined threshold is set as a small value. In the case that the offset angle of the face in the lip image sample data relative to the predetermined direction is smaller than the second predetermined threshold, e.g., 30°, it means that the face in the lip image sample data is a front face, i.e., the target lip image sample data is lip image sample data where the face is a front face. In the case that the offset angle of the face in the lip image sample data relative to the predetermined direction is greater than or equal to the second predetermined threshold, it means that the face in the lip image sample data is a side face.

Correspondingly, the target lip image sample data is called as high-definition front face data, and the other lip image sample data includes front face data and side face data.

In yet another possible embodiment of the present disclosure, the first target model is trained in accordance with the first model and the second model at first. To be specific, the first model and the second model are used as lip-speech synchronization discriminators, and the first target model is trained in accordance with the high-definition front face data and the other lip image sample data. After the training, based on model parameters of the first target model, the first target model is continuously trained in accordance with the third model and the fourth model, so as to adjust the model parameters of the first target model. To be specific, the third model and the fourth model are used as lip-speech synchronization discriminators, the first target model is trained in accordance with the high-definition front face data, and the model parameters of the first target model are fine-tuned at a learning rate of 0.1.

It should be appreciated that, before training the first target model, the first model, the second model, the third model and the fourth model need to be trained in advance.

The first model trained in accordance with the target lip image sample data and the other lip image sample data is expressed as syncnet-face-all, which has a very strong generalization ability. In other words, the first model may stably determine whether the lip image data synchronizes with the speech segment no matter whether the lip image sample data is the side face data, the front face data or the high-definition front face data.

The second model trained in accordance with the target lip image sample data and the other lip image sample data, i.e., the image data in the lip region tailored from the lip image sample data, is expressed as syncnet-mouth-all, which also has a very strong generalization ability. In other words, the second model may stably determine whether the image data in the lip region synchronizes with the speech segment no matter whether the lip image sample data is the side face data, the front face data or the image data in the lip region in the high-definition front face data.

In addition, in order to ensure the generalization of the first model and the second model, the high-definition front face data at a ratio of 0.2 is further obtained, and then data enhancement, e.g., blurring or color transfer, is performed.

The third model obtained through training the first model in accordance with the target lip image sample data is expressed as syncnet-face-hd, which has relatively high accuracy for determining the lip-speech synchronization, so as to accurately determine whether the lip image data synchronizes with the speech segment.

The fourth model obtained through training the second model in accordance with the target lip image sample data, i.e., the image data in the lip region tailored from the lip image sample data, is expressed as syncnet-mouth-hd, which has relatively high accuracy for determining the lip-speech synchronization, so as to accurately determine whether the image data in the lip region in the lip image data synchronizes with the speech segment.

In addition, syncnet-face-all is obtained through training in accordance with the target lip image sample data and the other lip image sample data, and then trained in accordance with the target lip image sample data on the basis of model parameters of syncnet-face-all, so as to finally obtain syncnet-face-hd. In this way, it is able to improve a model training speed. A training process of syncnet-mouth-hd is similar to that of syncnet-face-hd, which will not be particularly defined herein.

When the first model and the second model serve as a part of the first target model or the third model and the fourth model serve as a part of the first target model, during the training of the first target model, the first model, the second model, the third model and the fourth model have already been trained in advance, so it is able to accurately discriminate the lip-speech synchronization. Hence, when updating the model parameters of the first target model, model parameters of the first model, the second model, the third model and the fourth model are fixed, i.e., the model parameters are not updated.

In this embodiment of the present disclosure, the first target model is trained in accordance with the first model and the second model, and then the speech segment and the target face image data are inputted into the first target model to perform the first lip driving operation, so as to obtain the first lip image data about the virtual object driven by the speech segment. The first target model is obtained through training the first model, and after the first lip driving operation, the integrity of the face in the lip image data generated by the first target model, e.g., a chin, and a transition portion between the face and a background, is excellent. However, the lip region occupies a relatively small area in the entire face, and after downsampling, features in the lip region easily disappear, so some lip features to be learned by the first target model are missed out, and the lip texture in the lip image data, e.g., tooth texture, is insufficiently clear. Hence, the lip region is enlarged, the second model is created, the first target model is trained in accordance with the first model and the second model, and then the lip image data is generated through the first target model. In this way, it is able to pay attention to some detailed features in the lip region, e.g., a tooth feature, while ensuring the lip-speech synchronization between the lip image data and the speech segment, and enable the lip texture in the face in the lip image data generated by the first target model, e.g., the tooth texture, to be clear, thereby to improve the quality of the lip image data about the virtual object.

In addition, the lip-speech synchronization between the lip image data and the speech segment is affected not only by movement in a peripheral region of the face, e.g., the chin, but also by the opening and closing of the lip. Hence, when the first target model is trained in accordance with the first model and the second mode and the lip image data is generated by the first target model, it is able to improve the accuracy of the lip-speech synchronization between the lip image data and the speech segment.

In a possible embodiment of the present disclosure, the first target model is obtained through: training the first model in accordance with target lip image sample data to obtain a third model; training the second model in accordance with the target lip image sample data to obtain a fourth model; and training the third model and the fourth model to obtain the first target model. The target lip image sample data has a definition greater than a first predetermined threshold, and an offset angle of a face in the target lip image sample data relative to a predetermined direction is smaller than a second predetermined threshold.

In this embodiment of the present disclosure, the first model is syncnet-face-all, the second model is syncnet-mouth-all, and the first target model is obtained through training the third model and the fourth model. The third model is obtained through training the first model in accordance with the target lip image sample data, and it is syncnet-face-hd. The fourth model is obtained through training the second model in accordance with the target lip image sample data, and it is syncnet-mouth-hd.

The first target model is directly obtained through training the third model and the fourth model. The third model is a model obtained through training the first model in accordance with the target lip image sample data, and the fourth model is a model obtained through training the second model in accordance with the target lip image sample data, so when the first target model is trained in accordance with the third model and the fourth model and the lip image data is generated by the first target model, it is able to generate a high-definition lip image while ensuring the lip-speech synchronization between the lip image data and the speech segment, and drive the lip of the face in a high-definition manner, thereby to meet the requirement in a high-definition scenario.

The first target model is also trained in accordance with the first model and the second model at first. To be specific, the first model and the second model are used as lip-speech synchronization discriminators, and the first target model is trained in accordance with the high-definition front face data and the other lip image sample data. After the training, based on model parameters of the first target model, the first target model is continuously trained in accordance with the third model and the fourth model, so as to adjust the model parameters of the first target model. To be specific, the third model and the fourth model are used as lip-speech synchronization discriminators, the first target model is trained in accordance with the high-definition front face data, and the model parameters of the first target model are fine-tuned at a learning rate of 0.1. In this way, it is able to generate a high-definition lip image while ensuring the lip-speech synchronization between the lip image data and the speech segment, and increase a training speed of the first target model.

In a possible embodiment of the present disclosure, the first lip driving operation includes: performing feature extraction on the target face image data and the speech segment to obtain a first feature of the target face image data and a second feature of the speech segment; aligning the first feature with the second feature to obtain a first target feature; and creating the first lip image data in accordance with the first target feature.

In this embodiment of the present disclosure, the feature extraction is performed on the target face image data and the speech segment through the generator in the first target model, so as to obtain the first feature of the target face image data and the second feature of the speech segment. The first feature includes a high-level global feature and/or a low-level detail feature of each image in the target face image data, and the second feature is an audio feature, e.g., a mel feature.

Next, the first feature is aligned with the second feature to obtain the first target feature. To be specific, a lip in a current speech segment is predicted in accordance with the second feature, and then the first feature is adjusted in accordance with the predicted lip so as to obtain the first target feature after alignment.

Then, the first lip image data is created in accordance with the first target feature in two ways. In a first way, an image is created in accordance with the first target feature to generate the first lip image data. In a second way, image regression is performed on the target face image data using an attention mechanism to obtain a mask image with respect to a lip-related region in the target face image data, image creation is performed in accordance with the first target feature to generate second lip image data, and then the target face image data, the second lip image data and the mask image are fused to obtain the first lip image data.

In this embodiment of the present disclosure, the feature extraction is performed on the target face image data and the speech segment through the first target model to obtain the first feature of the target face image data and the second feature of the speech segment, the first feature is aligned with the second feature to obtain the first target feature, and then the first lip image data is created in accordance with the first target feature. In this way, it is able for the first target model to drive the lip through the speech segment.

In a possible embodiment of the present disclosure, prior to creating the first lip image data in accordance with the first target feature, the first lip driving operation further includes performing image regression on the target face image data through an attention mechanism to obtain a mask image with respect to a lip-related region in the target face image data. The creating the first lip image data in accordance with the first target feature includes: generating second lip image data about the virtual object driven by the speech segment in accordance with the first target feature; and fusing the target face image data, the second lip image data and the mask image to obtain the first lip image data.

In this embodiment of the present disclosure, the attention mechanism is introduced into the generator in the first target model, so as to perform the image regression on the target face image data, thereby to obtain the mask image with respect to the lip-related region in the target face image data. The lip-related region includes a chin region, a lip region, etc. The mask image includes a color mask and/or an attention mask with respect to the lip-related region.

The second lip image data about the virtual object driven by the speech segment is generated in accordance with the first target feature. To be specific, the image creation is performed in accordance with the first target feature, so as to generate the second lip image data.

Next, the target face image data, the second lip image data and the mask image are fused to obtain the first lip image data through I_{Yf}=A.C+(1−A).I_{Yo} (1), where I_{Yf} represents the first lip image data, A represents the mask image, C represents the second lip image data, and I_{Yo} represents the target face image data.

In this embodiment of the present disclosure, the image regression is performed on the target face image data through the attention mechanism to obtain the mask image with respect to the lip-related region in the target face image data. Next, the second lip image data about the virtual object driven by the speech segment is generated in accordance with the first target feature. Then, the target face image data, the second lip image data and the mask image are fused to obtain the first lip image data. In this way, it is able to focus on pixels in the lip-related region, thereby to obtain the more real lip image data with a higher sharpness level.

In a possible embodiment of the present disclosure, the first feature includes a high-level global feature and a low-level detail feature, the aligning the first feature with the second feature to obtain the first target feature includes aligning the high-level global feature and the low-level detail feature with the second feature to obtain the first target feature, and the first target feature includes the aligned high-level global feature and the aligned low-level detail feature.

In this embodiment of the present disclosure, a high-resolution image should be similar to a true high-resolution image in terms of both low-level pixel values and high-level abstract features, so as to ensure high-level global information and low-level detail information. Hence, the first feature of the target face image data includes the high-level global feature and the low-level detail feature, and the high-level global feature and the low-level detail feature are aligned with the second feature to obtain the first target feature.

Next, the first lip image data is created in accordance with the first target feature, so as to increase a resolution of an image in the first lip image data.

In addition, when training the first target model, a loss value of the high-level global feature and a loss value of the low-level detail feature are introduced to update the model parameters of the first target model, so as to improve a training effect of the first target model, and ensure high-level global information and low-level detail information in the high-resolution image.

### Second Embodiment

As shown in FIG. 2, the present disclosure provides in this embodiment a model training method, which includes: Step S201 of obtaining a first training sample set, the first training sample set including a first speech sample segment and first face image sample data about a virtual object sample; Step S202 of inputting the first speech sample segment and the first face image sample data into a first target model to perform a second lip driving operation, so as to obtain third lip image data about the virtual object sample driven by the first speech sample segment; Step S203 of performing lip-speech synchronization discrimination on the third lip image data and the first speech sample segment through a first model and a second model to obtain a first discrimination result and a second discrimination result, the first model being a lip-speech synchronization discriminative model with respect to lip image data, and the second model being a lip-speech synchronization discriminative model with respect to a lip region in the lip image data; Step S204 of determining a target loss value of the first target model in accordance with the first discrimination result and the second discrimination result; and Step S205 of updating a parameter of the first target model in accordance with the target loss value.

A training process of the first target model is described in this embodiment of the present disclosure.

In Step S201, the first training sample set includes a plurality of first speech sample segments and a plurality of pieces of first face image sample data corresponding to the first speech sample segments, as well as a lip image data label of the virtual object sample driven by the first speech sample segment.

The first speech sample segment is obtained in various ways, i.e., the first speech sample segment in the first training sample set is obtained in one or more ways. For example, a piece of speech is recorded in real time as the first speech sample segment, or a pre-stored piece of speech is obtained as the first speech sample segment, or a piece of speech is received from the other electronic device as the first speech sample segment, or a piece of speech is downloaded from the network as the first speech sample segment.

The first face image sample data is obtained in various ways, i.e., the first face image sample data in the first training sample set is obtained in one or more ways. For example, a video is recorded or some images are taken in real time as the first face image sample data, or a pre-stored video or a pre-stored image is obtained as the first face image sample data, or a video or images is received from the other electronic device as the first face image sample data, or a video or image is downloaded from the network as the first face image sample data.

The lip image data label of the virtual object sample driven by the first speech sample segment refers to a real video when the virtual object sample says the first speech sample segment, so its lip accuracy is relatively high. The lip image data label is obtained in various ways. For example, a video about the virtual object sample when the virtual object sample says the first speech sample segment is recorded as the lip image data label, or a pre-stored video about the virtual object sample when the virtual object sample says the first speech sample segment is obtained as the lip image data label, or a video about the virtual object sample when the virtual object sample says the first speech sample segment is received from the other electronic device as the lip image data label.

In addition, a high-resolution image should be similar to a true high-resolution image in terms of both low-level pixel values and high-level abstract features, so as to ensure high-level global information and low-level detail information. Hence, in order to improve a training effect of the first target model, high-definition lip image data is generated through the first target model, and the first training sample set further includes a high-level global feature label and a low-level detail feature label of the lip image data label.

The parameters of the first target model are updated in accordance with a loss value of the high-level global feature aligned with the speech feature of the first speech sample segment relative to the high-level global feature label and a loss value of the low-level detail feature aligned with the speech feature of the first speech sample segment relative to the low-level detail feature label, so as to increase the resolution of the lip image data generated through the first target model, thereby to achieve the lip image driving at a high definition.

In Step S202, the first speech sample segment and the first face image sample data are inputted into the first target model to perform the second lip driving operation, so as to obtain the third lip image data about the virtual object sample driven by the first speech sample segment. The second lip driving operation is performed in a similar way to the first lip driving operation, and thus will not be particularly defined herein.

In a possible embodiment of the present disclosure, the second lip driving operation includes: performing feature extraction on the first face image sample data and the first speech sample segment to obtain a fifth feature of the first face image sample data and a sixth feature of the first speech sample segment; aligning the fifth feature with the sixth feature to obtain a second target feature; and creating the third lip image data in accordance with the second target feature.

In the second lip driving operation, a way of performing the feature extraction on the first face image sample data and the first speech sample segment, a way of aligning the fifth feature with the sixth feature and a way of creating the third lip image data in accordance with the second target feature are similar to those in the first lip driving operation respectively, and thus will not be particularly defined herein.

In Step S203, lip-speech synchronization discrimination is performed on the third lip image data and the first speech sample segment through the first model and the second model, so as to obtain a first discrimination result and a second discrimination result. The first discrimination result represents an alignment degree between the third lip image data and the first speech sample segment, and the second discrimination result represents an alignment degree between the image data in the lip region in the third lip image data and the first speech sample segment.

To be specific, the feature extraction is performed by the first model on the third lip image data and the first speech sample segment, so as to obtain a feature of the third lip image data and a feature of the first speech sample segment, e.g., a 512-dimensional speech feature and a 512-dimensional lip image feature. Next, the two features are normalized and a cosine distance between them is calculated. The larger the cosine distance, the larger the alignment degree of the third lip image data relative to the first speech sample segment, and vice versa. A way of performing, by the second model, the lip-speech synchronization discrimination on the third lip image data and the first speech sample segment is similar to a way of performing, by the first model, the lip-speech synchronization discrimination on the third lip image data and the first speech sample segment, merely with such a difference that the second model performs the lip-speech synchronization discrimination on the image data in the lip region in the third lip image data and the first speech sample segment.

In Step S204, the target loss value of the first target model is determined in accordance with the first discrimination result and the second discrimination result.

In a possible embodiment of the present disclosure, the target loss value of the first target model is determined directly in accordance with the first discrimination result and the second discrimination result. For example, an alignment degree of the third lip image data relative to the first speech sample segment is determined in accordance with the first discrimination result and the second discrimination result, and then the target loss value is determined in accordance with the alignment degree. The larger the alignment degree, the smaller the target loss value, and vice versa.

In another possible embodiment of the present disclosure, the target loss value of the first target model is determined in accordance with a loss value of the third lip image data relative to the lip image data label as well as the first discrimination result and the second discrimination result. To be specific, the target loss value is obtained through superimposition, e.g., weighted superimposition, on the loss value of the third lip image data relative to the lip image data label and a loss value determined in accordance with the first discrimination result and the second discrimination result.

In yet another possible embodiment of the present disclosure, the target loss value of the first target model is determined in accordance with a loss value of the aligned high-level global feature relative to the high-level global feature label, a loss value of the aligned low-level detail feature relative to the low-level detail feature label as well as the first discrimination result and the second discrimination result. To be specific, the target loss value is obtained through superimposition, e.g., weighted superimposition, on the loss value of the aligned high-level global feature relative to the high-level global feature label, the loss value of the aligned low-level detail feature relative to the low-level detail feature label as well as the loss value determined in accordance with the first discrimination result and the second discrimination result.

A loss value of a feature relative to a feature label is calculated through

$${l}_{feat}^{Φ , j} ( {y}^{︵} , y ) = \frac{1}{{C}_{j} {H}_{j} {W}_{j}} {‖ {Φ}_{j} ( {y}^{︵} ) - {Φ}_{j} ( y ) ‖}_{2}^{2} , \qquad ( 2 )$$

where l_{feat}^{Φ,j}(ŷ,y) represents the loss value of the feature relative to the feature label, j represents an input serial number of the image data, Cⱼ represents a feature channel, Hⱼ and Wⱼ represent a height and a width of the feature, ŷ represents the extracted feature, and y is the feature label.

In addition, the target loss value is also obtained through weighted superimposition on the loss value of the aligned high-level global feature relative to the high-level global feature label, the loss value of the aligned low-level detail feature relative to the low-level detail feature label, the loss value of the third lip image data relative to the lip image data label, the loss value corresponding to the first discrimination result and the loss value corresponding to the second discrimination result through Loss=loss_l1+loss_feat*wt_feat+loss_sync-face*wt_face+loss_sync-mouth*wt_mouth+loss_l2 (3), where Loss represents the target loss value, loss_l1 represents the loss value of the aligned low-level detail feature relative to the low-level detail feature label, loss_l2 represents the loss value of the third lip image data relative to the lip image data label, loss_feat represents the loss value of the aligned high-level global feature relative to the high-level global feature label, loss_sync-face represents the loss value corresponding to the first discrimination result, loss_sync-mouth represents the loss value corresponding to the second discrimination result, and wt_feat , wt_face and wt_mouth are weights for the loss values respectively and they may be set according to the practical need, which will thus not be particularly defined herein.

In Step S205, the model parameters of the first target model are updated through back propagation in accordance with the target loss value. For example, parameters of the generator in the first target model and parameters of the discriminator for discriminating whether the third lip image data is similar to the lip image data label are updated.

When the first model and the second model are sub-models of the first target model and the parameters of the first target model are updated, parameters of the first model and the second model are not updated, for example.

When the target loss value is converged and relatively small, the first target model has been trained successfully, and it may be used to perform the lip driving on the virtual object.

In this embodiment of the present disclosure, the first training sample set is obtained, and it includes the first speech sample segment and the first face image sample data about the virtual object sample. Next, the first speech sample segment and the first face image sample data are inputted into the first target model to perform the second lip driving operation, so as to obtain the third lip image data about the virtual object sample driven by the first speech sample segment. Next, the lip-speech synchronization discrimination is performed on the third lip image data and the first speech sample segment through the first model and the second model to obtain the first discrimination result and the second discrimination result, the first model is the lip-speech synchronization discriminative model with respect to the lip image data, and the second model is the lip-speech synchronization discriminative model with respect to the lip region in the lip image data. Next, the target loss value of the first target model is determined in accordance with the first discrimination result and the second discrimination result. Then, the parameter of the first target model is updated in accordance with the target loss value, so as to train the first target model. In this way, it is able to pay attention to some detailed features in the lip region, e.g., a tooth feature, while ensuring the lip-speech synchronization between the lip image data and the speech segment, and enable the lip texture in the face in the lip image data generated by the first target model, e.g., the tooth texture, to be clear, thereby to improve the quality of the lip image data about the virtual object.

In a possible embodiment of the present disclosure, prior to Step S202, the model training method further includes: obtaining a second training sample set, the second training sample set including a second speech sample segment, first lip image sample data and a target label, the target label being used to represent whether the second speech sample segment synchronizes with the first lip image sample data; performing feature extraction on the second speech sample segment and target data through a second target model, so as to obtain a third feature of the second speech sample segment and a fourth feature of the target data; determining a feature distance between the third feature and the fourth feature; and updating a parameter of the second target model in accordance with the feature distance and the target label. In the case that the target data is the first lip image sample data, the second target model is the first model. Alternatively in the case that the target data is data in a lip region in the first lip image sample data, the second target model is the second model.

A training process of the first model or the second model is specifically described in this embodiment of the present disclosure.

To be specific, at first the second training sample set is obtained and includes the second speech sample segment, the first lip image sample data and the target label, and the target label is used to represent whether the second speech sample segment synchronizes with the first lip image sample data. The second training sample set includes a plurality of second speech sample segments and a plurality of pieces of first lip image sample data. With respect to a second speech sample segment, the second training sample set may include the first lip image sample data aligned with, or not aligned with, the second speech sample segment.

All or a part of the first lip image sample data in the second training sample set is high-definition front face data. For example, the second training sample set includes the high-definition front face data, front face data and side face data, which will not be particularly defined herein. When the second training sample set includes the high-definition front face data, the front face data and the side face data, the second target model trained in accordance with the second training sample set has an excellent generalization capability.

During the implementation, the second training sample set includes a positive sample expressed as {F_{c}^{v},F_{c}^{a}} and a negative sample expressed as {F_{c}^{v},F_{c(j)}^{a-}}. The positive sample indicates that the second speech sample segment synchronizes with the first lip image sample data, and the negative sample indicates that the second speech sample segment does not synchronize with the first lip image sample data.

In addition, when creating the positive sample, the positive sample is presented as the alignment of an image with a speech in a same video. There are two types of negative samples, i.e., one is created in accordance with data about an image and a speech that are not aligned with each other in a same video, and the other is created in accordance with data about images and speeches in different videos.

Next, the feature extraction is performed on the second speech sample segment and the target data through the second target model, so as to obtain the third feature of the second speech sample segment and the fourth feature of the target data. In the case that the target data is the first lip image sample data, the second target model is the first model. Alternatively in the case that the target data is data in a lip region in the first lip image sample data, the second target model is the second model.

During the implementation, the positive sample or the negative sample is inputted into the second target model, so as to perform the feature extraction on the data in the positive sample or the negative sample, thereby to obtain the fourth feature of the lip image data, e.g., a 512-dimensional fourth feature, and the third feature of the speech sample segment, e.g., a 512-dimensional third feature. The third feature and the fourth feature are normalized, and then the feature distance between the two, e.g., a cosine distance, is calculated through a distance calculation formula.

Next, in the process of updating the model parameters of the second target model, depending on synchronization information between an audio and a video, i.e., the target label, a contrastive loss is created using a balance training policy in accordance with the feature distance and the target label, so as to perform alignment constraint (i.e., a principle where the smaller the cosine distance determined in accordance with the positive sample, the better; and the larger the cosine distance determined in accordance with the negative sample, the better), thereby to update the parameters of the second target model.

In order to ensure the generalization of the second target model, the high-definition front face data at a ratio of 0.2 is obtained, and then data enhancement, e.g., blurring or color transfer, is performed.

In order to ensure the fairness, during the training, random videos are not adopted, and instead, each video is trained once in each model updating epoch. The contrastive loss of the second target model is expressed as

$${Γ}_{c}^{v 2 a} = - log [ \frac{exp ( D ( {F}_{c}^{v} , {F}_{c}^{a} ) )}{exp ( D ( {F}_{c}^{v} , {F}_{c}^{a} ) ) + {\sum }_{j = 1}^{N -} exp ( D ( {F}_{c}^{v} , {F}_{c 〈 j )}^{a -} ) )} ] , \qquad ( 4 )$$

where Γ_{c}^{v2a} represents the contrastive loss, and N represents the quantity of pieces of first lip image sample data, i.e., the quantity of videos.

Then, the parameters of the second target model are updated in accordance with the contrastive loss. When the contrastive loss is converged and relatively small, the second target model has been updated successfully, so that the cosine distance determined in accordance with the positive sample is small and the cosine distance determined in accordance with the negative sample is large.

In this embodiment of the present disclosure, the second training sample set is obtained and includes the second speech sample segment, the first lip image sample data and the target label, and the target label is used to represent whether the second speech sample segment synchronizes with the first lip image sample data. Next, the feature extraction is performed on the second speech sample segment and the target data through the second target model, so as to obtain the third feature of the second speech sample segment and the fourth feature of the target data. Next, the feature distance between the third feature and the fourth feature is determined. Then, the parameter of the second target model is updated in accordance with the feature distance and the target label. In the case that the target data is the first lip image sample data, the second target model is the first model. Alternatively in the case that the target data is data in the lip region in the first lip image sample data, the second target model is the second model. In this way, it is able to train the first model and the second model in advance, and keep the parameters of the first model and the second model unchanged when training the first target model subsequently, and ensure a lip-speech synchronization discrimination effect, thereby to improve the training efficiency of the first target model.

In a possible embodiment of the present disclosure, subsequent to Step S205, the model training method further includes taking a third model and a fourth model as a discriminator for the updated first target model, and training the updated first target model in accordance with second face image sample data, so as to adjust the parameter of the first target model. The third model is obtained through training the first model in accordance with target lip image sample data, the fourth model is obtained through training the second model in accordance with the target lip image sample data, each of the target lip image sample data and the second face image sample data has a definition greater than a first predetermined threshold, and an offset angle of a face in each of the target lip image sample data and the second face image sample data relative to a predetermined direction is smaller than a second predetermined threshold.

In this embodiment of the present disclosure, the first model and the second model are trained in accordance with the high-definition front face data, the front face data and the side face data. The first model is expressed as syncnet-face-all, the second model is expressed as syncnet-mouth-all, and each of them has a strong generalization capability.

The third model is obtained through training the first model in accordance with the target lip image sample data, and it is expressed as syncnet-face-hd. The fourth model is obtained through training the second model in accordance with the target lip image sample data, and it is expressed as syncnet-mouth-hd. Each of them has high lip-speech synchronization discrimination accuracy, so it is able to accurately perform the lip-speech synchronization discrimination on the high-definition lip image data.

In this embodiment of the present disclosure, based on the fact that the first target model has been successfully trained in accordance with the first model and the second model, the third model and the fourth model are taken as the discriminators of the updated first target model, and the updated first target model is trained in accordance with the second face image sample data, so as to adjust the parameter of the first target model. In other words, the first target model is trained continuously through replacing the first model with the third model and replacing the second model with the fourth model, so as to adjust the parameter of the first target model. In addition, the model parameters of the first target model are fine-tuned at a learning rate of 0.1. In this way, it is able to improve the training efficiency of the first target model, and obtain, through training, the first target model for driving the high-definition lip image while ensuring the lip-speech synchronization.

In a possible embodiment of the present disclosure, the target lip image sample data is obtained through: obtaining M pieces of second lip image sample data, M being a positive integer; calculating an offset angle of a face in each piece of second lip image sample data relative to the predetermined direction; selecting the second lip image sample data where the offset angle is smaller than the second predetermined threshold from the M pieces of second lip image sample data; and performing face definition enhancement on the second lip image sample data where the offset angle is smaller than the second predetermined threshold so as to obtain the target lip image sample data.

In this embodiment of the present disclosure, the M pieces of second lip image sample data are obtained, and the second lip image sample data includes high-definition front face data, front face data or side face data. An object in this embodiment of the present disclosure is to select the high-definition front face data from the M pieces of second lip image sample data, so as to provide a solution to the obtaining of the high-definition front face data.

To be specific, a large quantity of second lip image sample data is crawled from the network, and non-shielded face images and speech features are extracted through a face detection and alignment model. The non-shielded face images and the speech features are taken as the training samples for the model.

A face offset angle in the extracted face image is calculated through a face alignment algorithm PRNet, and then the front face data and the side face data are filtered through in accordance with the face offset angle. In the case of a front face scenario, the face image where the face offset angle is smaller than 30° is determined as the front face data. Usually, the front face data includes lip information and tooth information, while the side face data substantially merely includes the lip information.

Then, face ultra-definition enhancement is performed through a face enhancement model GPEN, so as to enable the enhanced face image to be clear. An image output scale is defined as 256, and the enhancement operation is merely performed on the front face data, so as to finally filter through the target lip image sample data from the M pieces of second lip image sample data. In this way, it is able to provide a solution to the obtaining of the high-definition front face data, and filter through the reliable model training data from the obtained image data on the premise that the quality of the image data is not specifically defined.

### Third Embodiment

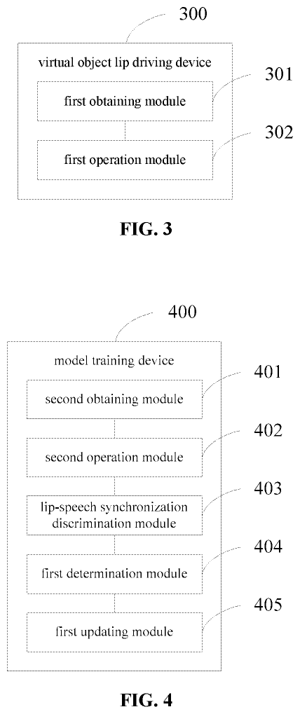

As shown in FIG. 3, the present disclosure provides in this embodiments a virtual object lip driving device 300, which includes: a first obtaining module 301 configured to obtain a speech segment and target face image data about a virtual object; and a first operation module 302 configured to input the speech segment and the target face image data into a first target model to perform a first lip driving operation, so as to obtain first lip image data about the virtual object driven by the speech segment. The first target model is trained in accordance with a first model and a second model, the first model is a lip-speech synchronization discriminative model with respect to lip image data, and the second model is a lip-speech synchronization discriminative model with respect to a lip region in the lip image data.

In a possible embodiment of the present disclosure, the first target model is obtained through: training the first model in accordance with target lip image sample data to obtain a third model; training the second model in accordance with the target lip image sample data to obtain a fourth model; and training the third model and the fourth model to obtain the first target model. The target lip image sample data has a definition greater than a first predetermined threshold, and an offset angle of a face in the target lip image sample data relative to a predetermined direction is smaller than a second predetermined threshold.

In a possible embodiment of the present disclosure, the first operation module includes: an extraction unit configured to perform feature extraction on the target face image data and the speech segment to obtain a first feature of the target face image data and a second feature of the speech segment; an alignment unit configured to align the first feature with the second feature to obtain a first target feature; and a creation unit configured to create the first lip image data in accordance with the first target feature.

In a possible embodiment of the present disclosure, the virtual object lip driving device further includes an image regression module configured to perform image regression on the target face image data through an attention mechanism to obtain a mask image with respect to a lip-related region in the target face image data. The creation unit is specifically configured to: generate second lip image data about the virtual object driven by the speech segment in accordance with the first target feature; and fuse the target face image data, the second lip image data and the mask image to obtain the first lip image data.

In a possible embodiment of the present disclosure, the first feature includes a high-level global feature and a low-level detail feature. The alignment unit is specifically configured to align the high-level global feature and the low-level detail feature with the second feature to obtain the first target feature, and the first target feature includes the aligned high-level global feature and the aligned low-level detail feature.

The virtual object lip driving device 300 in this embodiment of the present disclosure is used to implement the above-mentioned virtual object lip driving method with a same beneficial effect, which will not be particularly defined herein.

### Fourth Embodiment

As shown in FIG. 4, the present disclosure provides in this embodiment a model training device 400, which includes: a second obtaining module 401 configured to obtain a first training sample set, the first training sample set including a first speech sample segment and first face image sample data about a virtual object sample; a second operation module 402 configured to input the first speech sample segment and the first face image sample data into a first target model to perform a second lip driving operation, so as to obtain third lip image data about the virtual object sample driven by the first speech sample segment; a lip-speech synchronization discrimination module 403 configured to perform lip-speech synchronization discrimination on the third lip image data and the first speech sample segment through a first model and a second model to obtain a first discrimination result and a second discrimination result, the first model being a lip-speech synchronization discriminative model with respect to lip image data, and the second model being a lip-speech synchronization discriminative model with respect to a lip region in the lip image data; a first determination module 404 configured to determine a target loss value of the first target model in accordance with the first discrimination result and the second discrimination result; and a first updating module 405 configured to update a parameter of the first target model in accordance with the target loss value.

In a possible embodiment of the present disclosure, the model training device further includes: a third obtaining module configured to obtain a second training sample set, the second training sample set including a second speech sample segment, first lip image sample data and a target label, the target label being used to represent whether the second speech sample segment synchronizes with the first lip image sample data; a feature extraction module configured to perform feature extraction on the second speech sample segment and target data through a second target model, so as to obtain a third feature of the second speech sample segment and a fourth feature of the target data; a second determination module configured to determine a feature distance between the third feature and the fourth feature; and a second updating module configured to update a parameter of the second target model in accordance with the feature distance and the target label. In the case that the target data is the first lip image sample data, the second target model is the first model. Alternatively in the case that the target data is data in a lip region in the first lip image sample data, the second target model is the second model.

In a possible embodiment of the present disclosure, the model training device further includes a model training module configured to take a third model and a fourth model as a discriminator for the updated first target model, and train he updated first target model in accordance with second face image sample data, so as to adjust the parameter of the first target model. The third model is obtained through training the first model in accordance with target lip image sample data, the fourth model is obtained through training the second model in accordance with the target lip image sample data, each of the target lip image sample data and the second face image sample data has a definition greater than a first predetermined threshold, and an offset angle of a face in each of the target lip image sample data and the second face image sample data relative to a predetermined direction is smaller than a second predetermined threshold.

In a possible embodiment of the present disclosure, the target lip image sample data is obtained through: obtaining M pieces of second lip image sample data, M being a positive integer; calculating an offset angle of a face in each piece of second lip image sample data relative to the predetermined direction; selecting the second lip image sample data where the offset angle is smaller than the second predetermined threshold from the M pieces of second lip image sample data; and performing face definition enhancement on the second lip image sample data where the offset angle is smaller than the second predetermined threshold so as to obtain the target lip image sample data.

The model training device 400 in this embodiment of the present disclosure is used to implement the above-mentioned model training method with a same beneficial effect, which will not be particularly defined herein.

The collection, storage, usage, processing, transmission, supply and publication of personal information involved in the embodiments of the present disclosure comply with relevant laws and regulations, and do not violate the principle of the public order.

The present disclosure further provides in some embodiments an electronic device, a computer-readable storage medium and a computer program product.

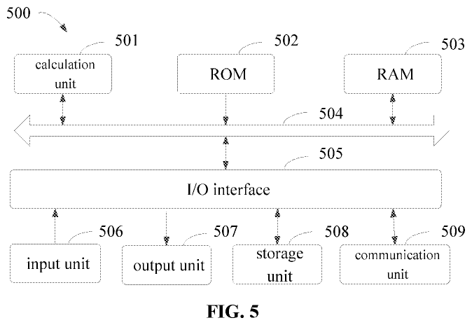

FIG. 5 is a schematic block diagram of an exemplary electronic device 500 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 5, the electronic device 500 includes a computing unit 501 configured to execute various processings in accordance with computer programs stored in a Read Only Memory (ROM) 502 or computer programs loaded into a Random Access Memory (RAM) 503 via a storage unit 508. Various programs and data desired for the operation of the electronic device 500 may also be stored in the RAM 503. The computing unit 501, the ROM 502 and the RAM 503 may be connected to each other via a bus 504. In addition, an input/output (I/O) interface 505 may also be connected to the bus 504.

Multiple components in the electronic device 500 are connected to the I/O interface 505. The multiple components include: an input unit 506, e.g., a keyboard, a mouse and the like; an output unit 507, e.g., a variety of displays, loudspeakers, and the like; a storage unit 508, e.g., a magnetic disk, an optic disk and the like; and a communication unit 509, e.g., a network card, a modem, a wireless transceiver, and the like. The communication unit 509 allows the electronic device 500 to exchange information/data with other devices through a computer network and/or other telecommunication networks, such as the Internet.

The computing unit 501 may be any general purpose and/or special purpose processing components having a processing and computing capability. Some examples of the computing unit 501 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 501 carries out the aforementioned methods and processes, e.g., the virtual object lip driving method or the model training method. For example, in some embodiments of the present disclosure, the virtual object lip driving method or the model training method may be implemented as a computer software program tangibly embodied in a machine readable medium such as the storage unit 508. In some embodiments of the present disclosure, all or a part of the computer program may be loaded and/or installed on the electronic device 500 through the ROM 502 and/or the communication unit 509. When the computer program is loaded into the RAM 503 and executed by the computing unit 501, one or more steps of the foregoing virtual object lip driving method or the model training method may be implemented. Optionally, in some other embodiments of the present disclosure, the computing unit 501 may be configured in any other suitable manner (e.g., by means of firmware) to implement the virtual object lip driving method or the model training method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, a server of a distributed system, or a server combined with blockchain.

It should be appreciated that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A virtual object lip driving method performed by an electronic device, the virtual object lip driving method comprising:
obtaining a speech segment and target face image data about a virtual object; and
inputting the speech segment and the target face image data into a first target model to perform a first lip driving operation, so as to obtain first lip image data about the virtual object driven by the speech segment,
wherein the first target model is trained in accordance with a first model and a second model, the first model is a lip-speech synchronization discriminative model with respect to lip image data, and the second model is a lip-speech synchronization discriminative model with respect to a lip region in the lip image data.

2. The virtual object lip driving method according to claim 1, wherein the first target model is obtained through:
training the first model in accordance with target lip image sample data to obtain a third model;
training the second model in accordance with the target lip image sample data to obtain a fourth model; and
training the third model and the fourth model to obtain the first target model,
wherein the target lip image sample data has a definition greater than a first predetermined threshold, and an offset angle of a face in the target lip image sample data relative to a predetermined direction is smaller than a second predetermined threshold.

3. The virtual object lip driving method according to claim 1, wherein the first lip driving operation comprises:
performing feature extraction on the target face image data and the speech segment to obtain a first feature of the target face image data and a second feature of the speech segment;
aligning the first feature with the second feature to obtain a first target feature; and
creating the first lip image data in accordance with the first target feature.

4. The virtual object lip driving method according to claim 3, wherein prior to creating the first lip image data in accordance with the first target feature, the virtual object lip driving method further comprises performing image regression on the target face image data through an attention mechanism to obtain a mask image with respect to a lip-related region in the target face image data,
wherein the creating the first lip image data in accordance with the first target feature comprises:
generating second lip image data about the virtual object driven by the speech segment in accordance with the first target feature; and
fusing the target face image data, the second lip image data and the mask image to obtain the first lip image data.

5. The virtual object lip driving method according to claim 3, wherein the first feature comprises a high-level global feature and a low-level detail feature, and wherein aligning the first feature with the second feature to obtain the first target feature comprises:
aligning the high-level global feature and the low-level detail feature with the second feature to obtain the first target feature, wherein the first target feature comprises the aligned high-level global feature and the aligned low-level detail feature.

6. A model training method performed by an electronic device, the model training method comprising:
obtaining a first training sample set, the first training sample set comprising a first speech sample segment and first face image sample data about a virtual object sample;
inputting the first speech sample segment and the first face image sample data into a first target model to perform a second lip driving operation, so as to obtain third lip image data about the virtual object sample driven by the first speech sample segment;
performing lip-speech synchronization discrimination on the third lip image data and the first speech sample segment through a first model and a second model to obtain a first discrimination result and a second discrimination result, the first model being a lip-speech synchronization discriminative model with respect to lip image data, and the second model being a lip-speech synchronization discriminative model with respect to a lip region in the lip image data;
determining a target loss value of the first target model in accordance with the first discrimination result and the second discrimination result; and
updating a parameter of the first target model in accordance with the target loss value.

7. The model training method according to claim 6, wherein prior to inputting the first speech sample segment and the first face image sample data into the first target model to perform the second lip driving operation so as to obtain the third lip image data about the virtual object sample driven by the first speech sample segment, the model training method further comprises:
obtaining a second training sample set, the second training sample set comprising a second speech sample segment, first lip image sample data and a target label, the target label being used to represent whether the second speech sample segment synchronizes with the first lip image sample data;
performing feature extraction on the second speech sample segment and target data through a second target model, so as to obtain a third feature of the second speech sample segment and a fourth feature of the target data;
determining a feature distance between the third feature and the fourth feature; and
updating a parameter of the second target model in accordance with the feature distance and the target label,
wherein in the case that the target data is the first lip image sample data, the second target model is the first model, or
in the case that the target data is data in a lip region in the first lip image sample data, the second target model is the second model.

8. The model training method according to claim 7, wherein subsequent to updating the parameter of the first target model in accordance with the target loss value, the model training method further comprises:
taking a third model and a fourth model as a discriminator for the updated first target model, and training the updated first target model in accordance with second face image sample data, so as to adjust the parameter of the first target model,
wherein the third model is obtained through training the first model in accordance with target lip image sample data, the fourth model is obtained through training the second model in accordance with the target lip image sample data, each of the target lip image sample data and the second face image sample data has a definition greater than a first predetermined threshold, and an offset angle of a face in each of the target lip image sample data and the second face image sample data relative to a predetermined direction is smaller than a second predetermined threshold.

9. The model training method according to claim 8, wherein the target lip image sample data is obtained through:
obtaining M pieces of second lip image sample data, M being a positive integer;
calculating an offset angle of a face in each piece of second lip image sample data relative to the predetermined direction;
selecting the second lip image sample data where the offset angle is smaller than the second predetermined threshold from the M pieces of second lip image sample data; and
performing face definition enhancement on the second lip image sample data where the offset angle is smaller than the second predetermined threshold so as to obtain the target lip image sample data.

10. An electronic device, comprising at least one processor, and a memory in communication with the at least one processor, wherein the memory is configured to store therein at least one instruction to be executed by the at least one processor, and the at least one instruction is executed by the at least one processor so as to implement a virtual object lip driving method, the virtual object lip driving method comprising:
obtaining a speech segment and target face image data about a virtual object; and
inputting the speech segment and the target face image data into a first target model to perform a first lip driving operation, so as to obtain first lip image data about the virtual object driven by the speech segment,
wherein the first target model is trained in accordance with a first model and a second model, the first model is a lip-speech synchronization discriminative model with respect to lip image data, and the second model is a lip-speech synchronization discriminative model with respect to a lip region in the lip image data.

11. The electronic device according to claim 10, wherein the first target model is obtained through:
training the first model in accordance with target lip image sample data to obtain a third model;
training the second model in accordance with the target lip image sample data to obtain a fourth model; and
training the third model and the fourth model to obtain the first target model,
wherein the target lip image sample data has a definition greater than a first predetermined threshold, and an offset angle of a face in the target lip image sample data relative to a predetermined direction is smaller than a second predetermined threshold.

12. The electronic device according to claim 10, wherein the first lip driving operation comprises:
performing feature extraction on the target face image data and the speech segment to obtain a first feature of the target face image data and a second feature of the speech segment;
aligning the first feature with the second feature to obtain a first target feature; and
creating the first lip image data in accordance with the first target feature.

13. The electronic device according to claim 12, wherein prior to creating the first lip image data in accordance with the first target feature, the virtual object lip driving method further comprises performing image regression on the target face image data through an attention mechanism to obtain a mask image with respect to a lip-related region in the target face image data,
wherein the creating the first lip image data in accordance with the first target feature comprises:
generating second lip image data about the virtual object driven by the speech segment in accordance with the first target feature; and
fusing the target face image data, the second lip image data and the mask image to obtain the first lip image data.

14. The electronic device according to claim 12, wherein the first feature comprises a high-level global feature and a low-level detail feature, and wherein aligning the first feature with the second feature to obtain the first target feature comprises:
aligning the high-level global feature and the low-level detail feature with the second feature to obtain the first target feature, wherein the first target feature comprises the aligned high-level global feature and the aligned low-level detail feature.

15. An electronic device, comprising at least one processor, and a memory in communication with the at least one processor, wherein the memory is configured to store therein at least one instruction to be executed by the at least one processor, and the at least one instruction is executed by the at least one processor so as to implement the model training method according to claim 6.

16. The electronic device according to claim 15, wherein prior to inputting the first speech sample segment and the first face image sample data into the first target model to perform the second lip driving operation so as to obtain the third lip image data about the virtual object sample driven by the first speech sample segment, the model training method further comprises:
obtaining a second training sample set, the second training sample set comprising a second speech sample segment, first lip image sample data and a target label, the target label being used to represent whether the second speech sample segment synchronizes with the first lip image sample data;
performing feature extraction on the second speech sample segment and target data through a second target model, so as to obtain a third feature of the second speech sample segment and a fourth feature of the target data;
determining a feature distance between the third feature and the fourth feature; and
updating a parameter of the second target model in accordance with the feature distance and the target label,
wherein in the case that the target data is the first lip image sample data, the second target model is the first model, or
in the case that the target data is data in a lip region in the first lip image sample data, the second target model is the second model.

17. The electronic device according to claim 16, wherein subsequent to updating the parameter of the first target model in accordance with the target loss value, the model training method further comprises:
taking a third model and a fourth model as a discriminator for the updated first target model, and training the updated first target model in accordance with second face image sample data, so as to adjust the parameter of the first target model,
wherein the third model is obtained through training the first model in accordance with target lip image sample data, the fourth model is obtained through training the second model in accordance with the target lip image sample data, each of the target lip image sample data and the second face image sample data has a definition greater than a first predetermined threshold, and an offset angle of a face in each of the target lip image sample data and the second face image sample data relative to a predetermined direction is smaller than a second predetermined threshold.

18. The electronic device according to claim 17, wherein the target lip image sample data is obtained through:
obtaining M pieces of second lip image sample data, M being a positive integer;
calculating an offset angle of a face in each piece of second lip image sample data relative to the predetermined direction;
selecting the second lip image sample data where the offset angle is smaller than the second predetermined threshold from the M pieces of second lip image sample data; and
performing face definition enhancement on the second lip image sample data where the offset angle is smaller than the second predetermined threshold so as to obtain the target lip image sample data.

19. A non-transitory computer-readable storage medium storing therein at least one computer instruction, wherein the at least one computer instruction is executed by a computer so as to implement the virtual object lip driving method according to claim 1.

20. A non-transitory computer-readable storage medium storing therein at least one computer instruction, wherein the at least one computer instruction is executed by a computer so as to implement the model training method according to claim 6.
